(19) United States
(12) Patent Application Publication
(10) Pub. No.: US 2006/0198007 A1
(43) Pub. Date: Sep. 7, 2006

(54) Method of adjusting the resonant frequency of an assembled torsional hinged device

(75) Inventors: John W. Orcutt, Richardson, TX (US); Andrew Steven Dewa, Plano, TX (US); Arthur Monroe Turner, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/366,273

(22) Filed: Mar. 2, 2006

Related U.S. Application Data
(60) Provisional application No. 60/658,228, filed on Mar. 2, 2005.

(51) Int. Cl. G02B 26/08

(52) U.S. Cl. 359/224; 359/199

(57) ABSTRACT

A method of adjusting the resonant frequency of a torsional hinged device such as a resonant mirror is disclosed. Material is removed from selected portions (such as for example the tips) of the torsional hinged device to raise the frequency of said device into a selected frequency range.

This application claims the benefit of U.S. Provisional Application No. 60/658,228, filed on Mar. 2, 2005, entitled Manufacturing Silicon Torsional Optical Devices Utilizing Laser Milling, which application is hereby incorporated herein by reference.

### CROSS-REFERENCE TO RELATED APPLICATIONS

This application relates to the following co-pending and commonly assigned patent applications: Ser. No. XX/XXX,XXX (TI-60073), filed concurrently herewith, entitled Manufacturing A Mirror Plate Or Other Operational Structure Having Superior Flatness By Laser Milling For Use With Torsional Hinged Devices, which application is hereby incorporated herein by reference.

### TECHNICAL FIELD

The present invention relates to resonant torsional hinged mirrors and more particularly to the adjusting of the mirror resonant frequency after assembly of the mirror.

### BACKGROUND

In recent years, MEMS (Micro Electro Mechanical Systems) torsional hinged mirror structures have made significant strides as replacements for spinning polygon mirrors used as the engine for high speed printers and some types of display systems. Such torsional hinged mirror structures have certain advantages over the spinning polygon mirrors including lower cost and weight. However, every new technology has its own set of problems and using torsional hinged mirrors in precision applications is no exception.

One problem area is the manufacturing of such torsional hinged mirrors with a resonant frequency. The silicon components used to fabricate such torsional hinged may be manufactured from silicon wafers using semiconductor manufacturing process d methods. These silicon components are then combined with magnets to complete the y of many mirrors. Further, the resonant frequency of each mirror of the group of will likely be within a specified range of frequencies. Unfortunately, each of the ed mirrors will not have exactly the same resonant frequency because of variations in the processing, silicon wafer thickness, and the exact mass distribution of the composite including the magnet size and density as well as variations in adhesive bonds, etc.

Therefore, it will be appreciated that a method of adjusting the resonant frequency of bled torsional hinged mirror could be advantageous.

### SUMMARY OF THE INVENTION

These and other problems are generally solved or circumvented and technical advantages are generally achieved by embodiments of the present invention, which provides a method of adjusting the resonant frequency of an assembled torsional hinged structure (such as a mirror). The method comprises the step of mounting the torsional hinged device to a support structure, and providing a drive mechanism proximate the mounted torsional hinged device to oscillate the torsional hinged device at its resonant frequency. The resonant frequency is monitored, and is then raised to within a selected band of frequencies by laser milling material from selected portions (preferably a back portion) of the device or mirror.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIGS. 1A and 1B are a side and bottom view, respectively, of a torsional hinged mirror that will benefit from the teachings of this invention;

FIGS. 2A and 2B represent magnetic drive mechanisms suitable for driving the torsional hinged mirror of FIGS. 1A and 1B;

FIG. 3 is a schematic and block diagram illustrating a system incorporating the teachings of the present invention; and

FIG. 4 is a simplified view of FIG. 1A illustrating how laser milling or trimming to adjust the resonant frequency can be carried out as the torsional hinged device oscillates at its resonant frequency.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

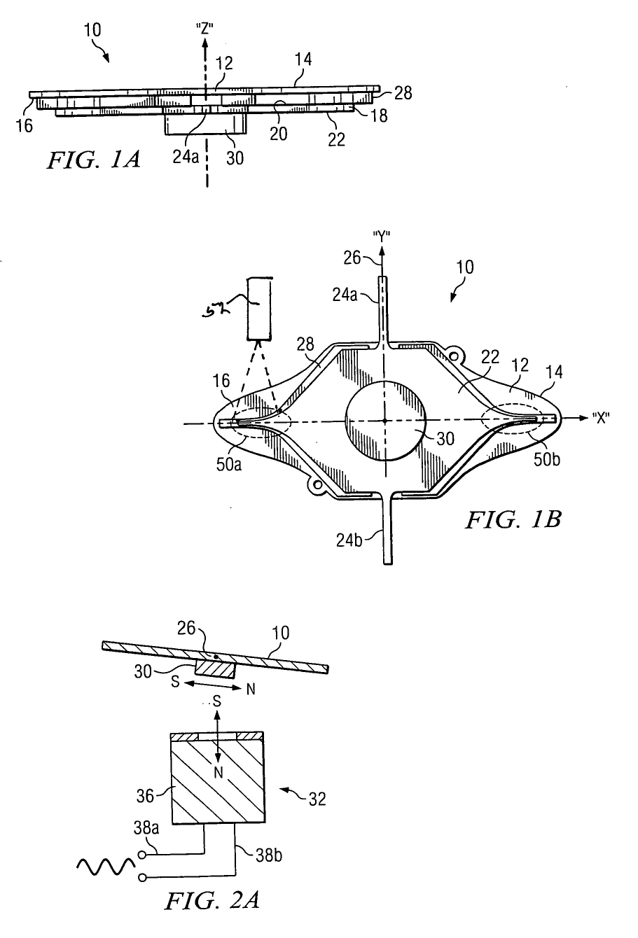

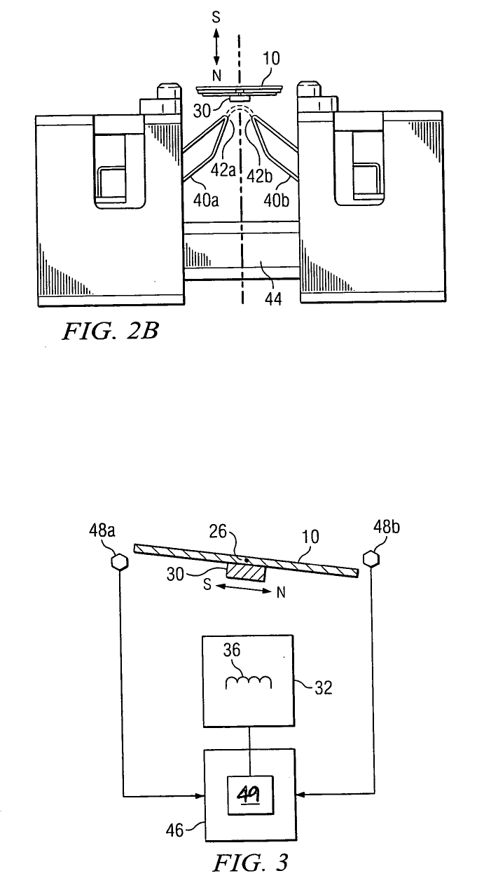

Referring now to FIGS. 1A and 1B, there is shown a side view and a bottom view of a multilayer torsional hinged resonant device incorporating the teachings of the present invention. As shown, the assembly 10 includes a front layer 12 having a top surface 14 (such as a reflective or mirror surface) and a back surface 16. Also included is a hinge layer 18 having a front side 20 and a magnet side 22. Hinge layer 18 also defines a pair of torsional hinges 24aand 24b that are attached to a support structure (not shown) for supporting the torsional hinged device 10. As will be appreciated by those skilled in the art and as can best be seen in FIG. 1B, device 10 oscillates on its torsional hinges 24a and 24b about pivot axis 26. Further, as will be discussed later and for purposes of this invention, device 10 preferably oscillates about axis 26 substantially at its resonant frequency. The torsional hinged device illustrated in FIGS. 1A and 1B is also shown as including a truss layer 28 and a permanent magnet 30. Permanent magnet 30 will typically cooperate with an electromagnetic coil (to be discussed hereinafter) as a drive mechanism to provide the necessary force to initiate and maintain the device 10 oscillating at its resonant frequency. Although the illustrated drive mechanism is magnetic, it will be appreciated that other types of drive mechanisms, such as inertial drive mechanisms, are also suitable for use with this invention. Truss layer 28 is not always necessary, but is included as shown in FIGS. 1A and 1B to provide increased structural stiffness to improve dynamic deformation, reduce the mass of the mirror near the tips and position the center of the mass of the device to lie along pivot axis 26. It should also be appreciated that the front layer 12 and the truss layer 28 may comprise separate layers bonded together, but preferably comprises a unitary structure etched from a single piece of silicon. Referring now to FIG. 2A, there is a diagram showing a simplified illustration of torsional hinged device 10 and one type of a magnetic drive mechanism. As shown, permanent magnet 30 is in place on the back side of device 10. Also shown is the magnetic drive mechanism 32 including a coil portion 36. Electrical leads 38aand 38b represent the coil leads that receive a drive signal, such as for example, a sinusoidal drive signal that has a frequency substantially equivalent to the resonant frequency of the resonant device 10. The sinusoidal drive signal passing through coil 36 continually changes the field N-S orientation above the coil portion 36. For example, FIG. 2A is shown with the field produced by the coil 36 having the South direction close to permanent magnet 30, and the North pole further away. However, as the sinusoidal drive signal continually changes from positive to negative and from negative to positive on input lines 38a and 38b, the field orientation from the coil 36 will also change from South to North and then back again from North to South at the same rate of the drive signal. Therefore, if the sinusoidal input signal to coil 36 is the same as the resonant frequency of the oscillating device or mirror, it will be appreciated that the mirror will oscillate at its resonant frequency with minimal drive power required. That is, as has been discussed, torsional hinged devices such as mirrors are particularly power efficient when operating at the resonant frequency of the device. It will also be appreciated by those skilled in the art that a continuous sinusoidal signal may not be required to maintain oscillation of the device 10 at its resonant frequency. One or more properly timed pulses may also be used effectively. FIG. 2B illustrates another magnetic drive mechanism that includes two pole pieces 40a and 40b that generate a magnetic drive flux that extends between tips 42a and 42b and interacts with magnet 30. The magnetic drive flux is generated by a drive coil 44. The remainder of the drive mechanism of FIG. 2B is similar to that of FIG. 2A, except that the magnetization of the magnet is perpendicular to the silicon hinge layer or plate surface and the pole pieces 40a and 40b now produce a field substantially parallel to the surface of the device or mirror 10 and perpendicular to the torsional hinges. Other drive mechanisms, including inertia drive mechanisms, are also suitable for use with the present invention.

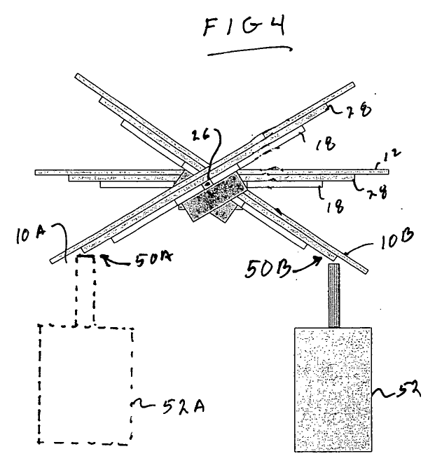

Referring now to FIG. 3, there is a simplified illustration of a torsional hinged device and drive system according to the teachings of the present invention. The elements of FIG. 3 that are the same or perform the same functions of FIGS. 2A and 2B have the same reference numbers. Also as shown in FIG. 3, there is included at least one sensor that monitors the angular position of the device 10 and provides a signal to computational circuitry 46. The system of FIG. 3 includes two sensors 48a and 48b. Computation circuit 46 also includes drive circuitry 49 that provides the appropriate drive signals (frequency and amplitude) to coil 36 of drive mechanism 32. Drive mechanism 32 interacts with permanent magnet 30 to initiate and maintain resonant oscillation of device 10.

As has been briefly discussed, device 10 preferably operates at resonance, and represents one of a multiplicity of torsional hinged devices (especially mirrors) preferably formed from a single crystal silicon wafer using semiconductor processing methods and steps. However, although the devices can be formed so that the resonant frequency falls within a range or band of frequencies, individual devices formed in the wafer will likely still have different resonant frequencies because of variations in fabrication steps and in assembling the device or mirror structure. For example, the thickness of the hinge plate or layer may vary as well as the width of the torsional hinge. Likewise, the thickness of the mirror or front layer and/or the truss layer may also vary in thickness because of variations in the etching process. If the device is a mirror, a reflective coating may be added to the front surface. The thickness of the deposited reflective coating may also slightly vary at different locations on the surface of the mirror and from mirror to mirror. The geometry and density of the permanent magnet may include variations that cause the mass moment of the assembled structure to vary. Also, if the device elements are bonded together, the thickness of the adhesive may vary over the bonded surface.

Studies indicate that these variations can produce frequency variations of ±3% or greater. Unfortunately, systems which use resonant scanning mirrors, such as laser printers or laser projection displays, have constraints on the operating frequency range of the resonant device that are more stringent than ±3%.

Furthermore, because these resonant devices are high-Q devices, the frequency of the drive signal must be very close to the resonant frequency of the device, or the sweep amplitude of the device may be significantly reduced. Consequently, since only a narrow range of resonant frequencies will be acceptable, the yield of the usable resonant devices without the teachings of the present invention will be low. If the yield is too low, there is little or no chance of using a resonant device in a commercial application.

The present invention provides a simple but elegant solution to this problem. More specifically referring to FIGS. 1A, 1B, and 3, according to the invention, the assembled device is oscillated at its resonant frequency as measured and determined by the sensors 48a and 48b and computation circuit 46 shown in FIG. 3. Also, to aid in understanding the invention, FIGS. 1A and 1B include the “X”, “Y”, and “Z” spatial axes. As shown, the “Y” axis corresponds to pivot axis 26 and the “X” axis lies on the same plane as the “Y” axis but is perpendicular to and runs along the long dimension of the mirror device. The “Z” axis extends through the center of the magnet and the mirror structure and is, of course, perpendicular to both the “X” axis and the “Y”axis. If the device resonates at a frequency less than that allowed by the specification limits, small equal amounts of material on each side of the “Y” axis is removed from the back side of the mirror by laser milling as indicated by laser 52. Suitable areas for removing material are shown by areas 50a and 50b in FIG. 1B. Removing this material will result in the resonant frequency of the device being increased or raised. Multiple passes of the milling laser allows small amounts or layers of material to be removed at each pass. This approach has been found to be particularly suitable. Therefore, by removing the material in small amounts, the material may be gradually removed until the resonant frequency is raised to a frequency within the allowed band of resonant frequencies. To maintain the device in proper balance around the “X” axis, the material at areas 50a and 50b should be removed by laser milling in substantially equal portions on each side of the center line (“X” axis) that is perpendicular to the pivot axis 26 (axis “Y”). Likewise, to maintain mass balance along the axis perpendicular to the mirror surface (axis “Z”) material should also be removed in substantially equal portions on each side of the “Z” axis. FIG. 1A illustrates laser milling while the mirror is in a static condition to trim the resonant frequency.

Referring to FIG. 4, there is shown a simplified side view of a minor device similar to FIG. 1A as the resonant frequency of the device is adjusted or trimmed by laser milling as it oscillates. As shown, FIG. 4 illustrates the two extreme rotational positions 10a and 10b and the neutral or relaxed position, and also illustrates how the laser 52 can trim or mill the areas 50aand 50b, according to the invention, as the oscillation of the device comes to a complete stop before reversing and rotating in the reverse direction. Although FIG. 4 illustrates the area 50bbeing trimmed, it will be appreciated that laser 52 can trim or adjust one area at a time, or a second laser 52a indicated by dashed lines can be used to trim the area 50a, so as to maintain a better balance of the mirror device during the trimming process.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, composition of matter, methods and steps described in the specification. As one of ordinary skill in the art will readily appreciate from the disclosure of the present invention, processes, compositions of matter, methods, or steps, presently existing or later to be developed, that perform substantially the same fiction or achieve substantially the same result as the corresponding embodiments described herein may be utilized according to the present invention. Accordingly, the appended claims are intended to include within their scope such processes, compositions of matter, methods, or steps.

What is claimed is:

1. A method of adjusting the resonant frequency of a torsional hinged device comprising the steps of:
mounting the torsional hinged device to a support structure;
oscillating said torsional hinged device about a pivot axis at the resonant frequency of said mounted torsional hinged device;
determining the frequency of the resonant oscillations of said device; and
laser milling the resonant torsional hinged device to remove material and lower the resonant frequency of the device.

2. The method of claim 1 wherein said torsional hinged device is a silicon MEMS structure.

3. The method of claim 1 wherein said torsional hinged device has a front side and a back side and said material is removed from said back side.

4. The method of claim 3 wherein substantially equal portions of material are removed from said device on each side of said pivot axis.

5. The method of claim 3 wherein substantially equal portions of material are removed from said device on each side of a centerline (“X” axis) of the device perpendicular to said pivot axis.

6. The method of claim 3 wherein substantially equal portions of material are removed at a location on each side of the “X” axis and along the axis perpendicular to the device surface (“Z” axis) to maintain mass balance along this axis.

7. The method of claim 1 wherein said torsional hinged device is a torsional hinged mirror.

8. The method of claim 7 wherein said torsional hinged mirror includes first and second mirror tip areas spaced apart by equal distances on each side of said pivot axis and said material is removed from said first and second tip areas.

9. The method of claim 1 wherein said step of removing material comprises removing the material with more than one pass of laser milling.

10. The method of claim 1 wherein said step of laser milling occurs as said torsional hinged device is oscillating.

11. The method of claim 1 wherein said step of laser milling occurs while said torsional hinged device is in a static condition.

12. A system for adjusting the resonant frequency of a torsional hinged device comprising:
a laser system for milling with a laser beam;
a support structure;
a torsional hinged device mounted to said support structure, said mounted torsional hinged device having a pivot axis and a resonant frequency;
a sensor and a computational circuitry to determine the resonant frequency of said mounted torsional hinged device;
a drive mechanism to drive said mounted torsional hinged device at its resonant frequency; and
said laser beam directed to selected areas on said torsional hinged device such that material is removed from said selected areas to change the resonant frequency of said mounted torsional hinged device to be within a range of frequencies.

13. The system of claim 12 wherein said torsional hinged device is a torsional hinged mirror.

14. The system of claim 12 wherein said drive mechanism is a magnetic drive mechanism.

15. The system of claim 13 wherein said torsional hinged mirror defines a pair of spaced apart tips on each side of said pivot axis and wherein said laser beam is directed at said spaced apart tips to remove material from said spaced apart tips.

16. The system of claim 12 wherein said torsional hinged device is a silicon MEMS structure.

17. The system of claim 12 wherein each side of a center line (“X” axis) of the device perpendicular to the pivot axis has substantially equal portions of said material removed therefrom.

18. The system of claim 12 wherein areas along the axis perpendicular to the device surface (“Z” axis) have equal portions of material removed therefrom.

19. The method of claim 11 wherein removal of material occurs while said torsional hinged device is in a static condition.
